(19) United States
(12) Patent Application Publication
(10) Pub. No.: US 2026/0336105 A1
(43) Pub. Date: Oct. 29, 2026

(54) METHOD EXECUTED BY ELECTRONIC DEVICE AND ELECTRONIC DEVICE

(71) Applicant: Samsung Electronics Co., Ltd., Suwon-si (KR)

(72) Inventors: Xiongfeng PENG, Beijing (CN); Jiaqian YU, Beijing (CN); Yi ZHOU, Beijing (CN); Yamin MAO, Beijing (CN); Chao ZHANG, Beijing (CN); Weiming LI, Beijing (CN); Sujin JANG, Suwon-si (KR); Dongwook LEE, Suwon-si (KR); Dae Hyun JI, Suwon-si (KR)

(73) Assignee: Samsung Electronics Co., Ltd., Suwon-si (KR)

(21) Appl. No.: 19/641,950

(22) Filed: Apr. 8, 2026

(30) Foreign Application Priority Data
Apr. 28, 2025 (CN) 202510551019.3
Nov. 5, 2025 (KR) 10-2025-0165252

(51) Int. Cl. B25J 9/16; G06F 40/40; G06V 10/42; G06V 10/44; G06V 10/82

(52) U.S. Cl. CPC B25J 9/163; B25J 9/1697; G06V 10/42; G06V 10/44; G06V 10/82; G06F 40/40

(57) ABSTRACT

A processor-implemented method includes determining visual features, first hidden features, and second hidden features through a feature extraction network within a first artificial intelligence (AI) model, based on a scene image and a first command to move a target object, determining an action type associated with the target object through an action model selector within the first AI model, based on the first hidden features, selecting a target action model from a set of candidate action models within the first AI model, based on the action type, and determining an action sequence associated with the target object through the target action model, based on the second hidden features and the visual features.

### CROSS-REFERENCE TO RELATED APPLICATIONS

This application claims the benefit under 35 USC § 119 (a) of Chinese Patent Application No. 202510551019.3, filed on Apr. 28, 2025 in the China National Intellectual Property Administration, and Korean Patent Application No. 10-2025-0165252, filed on Nov. 5, 2025 in the Korean Intellectual Property Office, the entire disclosures of which are incorporated herein by reference for all purposes.

### BACKGROUND

### 1. Field

The disclosure relates to a method executed by an electronic device and the electronic device.

### 2. Description of Related Art

Enabling robots to perform diverse tasks in diverse environments may be a core challenge in robotics technology. Typical robot learning schemes may develop strategies using datasets designed for a specific robot and its specific tasks. The vision-language-action (VLA) model may extend pre-trained vision-language models to the robotics field.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes determining visual features, first hidden features, and second hidden features through a feature extraction network within a first artificial intelligence (AI) model, based on a scene image and a first command to move a target object, determining an action type associated with the target object through an action model selector within the first AI model, based on the first hidden features, selecting a target action model from a set of candidate action models within the first AI model, based on the action type, and determining an action sequence associated with the target object through the target action model, based on the second hidden features and the visual features.

The set of candidate action models may include a first model associated with an arm movement and a second model associated with a gripper manipulation.

The determining of the action type may include outputting a prediction value of the action type associated with the target object through the action model selector within the first AI model, based on the first hidden features, determining the action type to be an arm movement, in response to the prediction value being less than a first threshold value, and determining the action type to be a gripper manipulation, in response to the prediction value being greater than or equal to the first threshold value.

The visual features may include global visual features and local visual features, and the determining of the action sequence may include either one of determining the action sequence associated with the target object through the first model, based on the second hidden features and the global visual features, in response to the action type being an arm movement, and determining the action sequence associated with the target object through the second model, based on the second hidden features and the local visual features, in response to the action type being a gripper manipulation.

The visual features may include global visual features and local visual features, and the determining of the action sequence may include either one of determining the action sequence associated with the target object through the first model, based on random noise, the second hidden features, and the global visual features, in response to the action type being an arm movement, and determining the action sequence associated with the target object through the second model, based on random noise, the second hidden features, and the local visual features, in response to the action type being a gripper manipulation.

The feature extraction network may include an encoder, a visual model, and a large language model (LLM), and the determining of the visual features, the first hidden features, and the second hidden features may include determining language features through the encoder, based on the first command, determining first visual features and second visual features through the visual model, based on the scene image, and determining the first hidden features and the second hidden features through the LLM, based on the first visual features and the language features.

The first visual features may be used to represent a basic structure and/or local information of the scene image, and the second visual features may be used to represent semantic information of the scene image.

The LLM may be an LLM Meta AI version 2 (LLAMA-2) model, the first hidden features may be acquired from hidden features of a second transformer layer of the LLAMA-2 model, the second hidden features may be acquired from hidden features of a last transformer layer, the second transformer layer may be used for action selection, and the last transformer layer may be used for action estimation.

The determining of the action sequence may include determining the action sequence associated with the target object through the target action model, based on the second hidden features and the second visual features.

The feature extraction network may include a Self-Distillation with No Labels version 2 (DINOv2) model and a Sigmoid loss for Language-Image Pre-training (SigLIP) model.

The method may include determining a first loss based on a prediction value of the action type and an action type label, determining a second loss based on a prediction value of the action sequence and an action sequence label, and adjusting network parameters of the first AI model based on the first loss and the second loss.

In one or more general aspects, a robot system includes a server configured to determine visual features, first hidden features, and second hidden features through a feature extraction network within a first artificial intelligence (AI) model, based on a scene image and a first command to move a target object, determine an action type associated with the target object through an action model selector within the first AI model, based on the first hidden features, select a target action model from a set of candidate action models within the first AI model, based on the action type, determine an action sequence associated with the target object through the target action model, based on the second hidden features and the visual features, and transmit the action sequence to a robot, and the robot configured to receive the action sequence and complete an action according to the action sequence.

The set of candidate action models may include a first model associated with an arm movement and a second model associated with a gripper manipulation.

For the determining of the action type, the server may be configured to output a prediction value of the action type associated with the target object through the action model selector within the first AI model, based on the first hidden features, determine the action type to be an arm movement, in response to the prediction value being less than a first threshold value, and determine the action type to be a gripper manipulation, in response to the prediction value being greater than or equal to the first threshold value.

The visual features may include global visual features and local visual features, and for the determining of the action sequence, the server may be configured to perform either one of determining the action sequence associated with the target object through the first model, based on the second hidden features and the global visual features, in response to the action type being an arm movement, and determining the action sequence associated with the target object through the second model, based on the second hidden features and the local visual features, in response to the action type being a gripper manipulation.

The visual features may include global visual features and local visual features, and for the determining of the action sequence, the server may be configured to perform either one of determining the action sequence associated with the target object through the first model, based on random noise, the second hidden features, and the global visual features, in response to the action type being an arm movement, and determining the action sequence associated with the target object through the second model, based on random noise, the second hidden features, and the local visual features, in response to the action type being a gripper manipulation.

The feature extraction network may include an encoder, a visual model, and a large language model (LLM), for the determining of the visual features, the first hidden features, and the second hidden features, the server may be configured to determine language features through the encoder, based on the first command, determine first visual features and second visual features through the visual model, based on the scene image, and determine the first hidden features and the second hidden features through the LLM, based on the first visual features and the language features, the first visual features may be used to represent a basic structure and/or local information of the scene image, and the second visual features may be used to represent semantic information of the scene image.

The LLM may be an LLM Meta AI version 2 (LLAMA-2) model, the first hidden features may be acquired from hidden features of a second transformer layer of the LLAMA-2 model, the second hidden features may be acquired from hidden features of a last transformer layer, the second transformer layer may be used for action selection, and the last transformer layer may be used for action estimation.

For the determining of the action sequence, the server may be configured to determine the action sequence associated with the target object through the target action model, based on the second hidden features and the second visual features.

In one or more general aspects, an electronic device includes one or more processors comprising processing circuitry, and memory comprising one or more storage media storing instructions that, when executed individually or collectively by the one or more processors, cause the electronic device to determine an action type associated with a target object, based on first hidden features determined through a large language model (LLM) based on first visual features extracted from a scene image, and based on the determined action type, determine an action sequence associated with the target object through either one of a first model associated with an arm movement, based on second hidden features determined through the LLM based on the first visual features and on global visual features extracted from the scene image, and a second model associated with a gripper manipulation, based on the second hidden features and local visual features extracted from the scene image.

Other features and aspects will be apparent from the following detailed description, the drawings, and the claims.

### BRIEF DESCRIPTION OF THE DRAWINGS

FIG. 1 illustrates an example of a system architecture according to one or more embodiments.

FIG. 2 illustrates an analysis of a difference between an arm movement and a gripper manipulation of a robot according to one or more embodiments.

FIG. 3 illustrates an example of a method executed by an electronic device according to one or more embodiments.

FIG. 4 illustrates an example of a method executed by an electronic device according to one or more embodiments.

FIG. 5 illustrates an example of an application scenario of a method executed by an electronic device according to one or more embodiments.

FIG. 6 illustrates an example of a dynamic action integration scheme according to one or more embodiments.

FIG. 7 illustrates an example of a structure of a robot system according to one or more embodiments.

FIG. 8 illustrates an example of a structure of a computer system of an electronic device according to one or more embodiments.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

When describing the examples with reference to the accompanying drawings, like reference numerals refer to like components regardless of drawing numbers and a repeated description related thereto will be omitted. In the description of examples, detailed description of well-known related technology will be omitted when it is deemed that such description will cause ambiguous interpretation of the present disclosure.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Unless otherwise specified, all terms (including technical or scientific terms) used herein have the same meaning as commonly understood by one of ordinary skill in the art to which the present disclosure pertains and specifically in the context on an understanding of this disclosure. Terms, such as those defined in commonly used dictionaries, should be construed to have meanings matching with contextual meanings in the relevant art and specifically in the context of the present disclosure, and are not to be construed as an ideal or excessively formal meaning unless otherwise defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

At least some functions of an apparatus or electronic device provided in one or more embodiments of the present disclosure may be implemented through an artificial intelligence (AI) model. For example, at least one module among several modules of the apparatus or electronic device may be implemented through an AI model. AI-related functions may be performed by a non-volatile memory, a volatile memory, and a processor.

The processor may include one or more processors. In this case, the one or more processors may be a general purpose processor (e.g., a central processing unit (CPU), an application processor (AP)), a graphics-only processing unit (e.g., a graphics processing unit (GPU), a vision processing unit (VPU)), and/or an AI-dedicated processor (e.g., a neural processing unit (NPU)).

The one or more processors may control the processing of input data according to a predefined operation rule or an AI model stored in the non-volatile memory and the volatile memory. The predefined operation rule or AI model may be provided through training or learning.

Here, providing the predefined operation rule or the AI model through learning may indicate acquiring a predefined operation rule or an AI model having desired features by applying a learning algorithm to a plurality of pieces of training data. The training may be performed by an apparatus or electronic device having an AI function according to one or more embodiments, and/or by a separate server, apparatus, and/or system.

The AI model may include a plurality of neural network layers. Each layer may perform a neural network operation by determining between input data (e.g., a determination result of a previous layer and/or input data of the AI model) of the layer and a plurality of weight values of a current layer. Examples of a neural network may include a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q-network, but are not limited thereto.

The learning algorithm may be a method of training a predetermined target device, for example, a robot, based on a plurality of pieces of training data and enabling, allowing, configuring, and/or controlling the predetermined target device to perform determination or prediction. The learning algorithm may include, but is not limited to, for example, supervised learning, unsupervised learning, semi-supervised learning, and/or reinforcement learning.

A method provided in the present disclosure may be relevant to one or more technical fields, such as voice, language, image, video, and/or data intelligence.

Optionally, in the field of voice or language, in a method performed by an electronic device according to the present disclosure, a method of recognizing a user's voice and interpreting a user's intention may include receiving a voice signal as an analog signal through a voice collection device (e.g., a microphone), and converting a voice portion into computer-readable text using an automatic speech recognition (ASR) model. Speech intention of the user may be acquired by interpreting the converted text using a natural language understanding (NLU) model. The ASR model or NLU model may be an AI model. The AI model may be processed by AI-specific processors with a hardware architecture configured for AI model processing. The AI model may be acquired through training. Here, “acquired through training” may be training a basic AI model with multiple training data through a training algorithm to acquire predefined operating rules or an AI model with desired features (or objectives). Linguistic understanding is a technique used to recognize and apply/process human language/text, including natural language processing, machine translation, dialogue system, question and answering, and/or speech recognition/synthesis.

Optionally, in the field of image or video, a method of identifying a trajectory, performed by an electronic device, according to the present disclosure may include acquiring output data for identifying an image or various features, knowledge, information, and the like within an image by using image data as input data of an AI model. The AI model may be acquired through training. Here, “acquired through training” may be training a basic AI model with multiple training data through a training algorithm to acquire predefined operating rules or an AI model with desired features (or objectives). The method of the present disclosure may relate to the field of visual understanding of AI technology, which is a technique of recognizing and processing objects similar to human vision, and may include, for example, object recognition, object tracking, image retrieval, person recognition, scene recognition, three-dimensional reconstruction/positioning, and/or image enhancement.

Optionally, in the field of data intelligence processing, according to the present disclosure, a method of inferring or predicting a trajectory by utilizing various knowledge using an AI model may be recommended/performed among methods performed by the electronic device. A processor of the electronic device may perform preprocessing operations on data to transform the data into a form suitable for use as input to the AI model. The AI model may be acquired through training. Here, “acquired through training” may be training a basic AI model with multiple training data through a training algorithm to acquire predefined operating rules or an AI model with desired features (or objectives). Reasoning prediction is a technique of performing logical reasoning and prediction by determining information such as knowledge-based reasoning, optimization prediction, preference-based planning, and/or recommendation.

Components included in one or more embodiments and components having a common function are described using the same names in other embodiments. Unless otherwise mentioned, the descriptions of the embodiments may be applicable to the following embodiments and thus, duplicated descriptions will be omitted for conciseness.

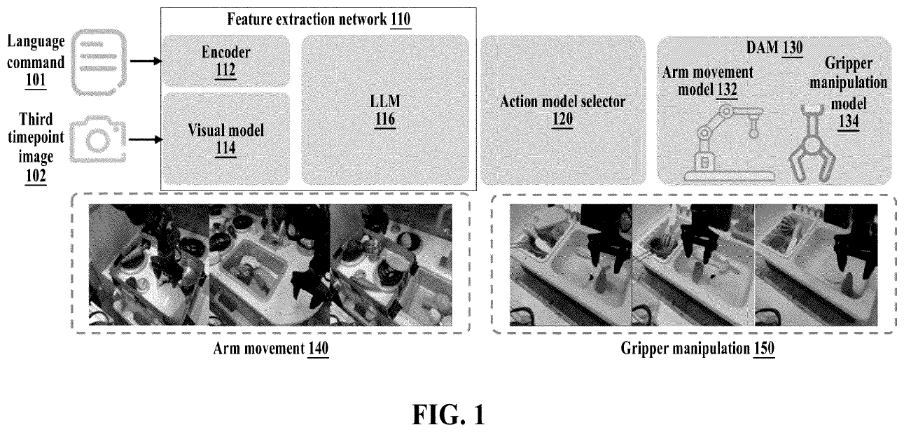

Hereinafter, a method executed by an electronic device and an electronic device are described in detail with reference to FIGS. 1 to 8.

FIG. 1 illustrates an example of a system architecture according to one or more embodiments.

Referring to FIG. 1, a robot action prediction model (which may also be referred to as a first AI model) may include a feature extraction network 110, an action model selector 120 (abbreviated as selector), and a dynamic action model (DAM) 130 (e.g., a target action model selected from a set of candidate action models).

The feature extraction network 110 may include an encoder 112, a visual model 114, and a large language model (LLM) 116. According to one or more embodiments, the DAM 130 may include an arm movement model 132 and a gripper manipulation model 134, and in the following description, the arm movement model 132 may be referred to as a first model, and the gripper manipulation model 134 may be referred to as a second model. In actual implementation, a wider variety of action models may be used, but embodiments are not limited thereto.

The robot action prediction model, when implemented, may configure different robots to perform physically different tasks while simultaneously receiving task descriptions of a third timepoint RGB image 102 and a language command 101. Formally, when the language command 101 and a visual observation Ot are given at time t, a robot action prediction model π may predict a time action sequence [aₜ, aₜ₊₁, . . . , a_{t+N}]=π(l, oₜ). In the disclosure, an action space at =[Δ{x}, Δθ, grip] may refer to an action of a gripper with seven degrees of freedom (DoF). Here, Δx denotes a relative parallel translation deviation of the gripper, Δθ denotes change in rotation, and grip ∈0, 1 represents an open/closed state of the gripper.

The system architecture may include five main components. 1) The encoder 112: may encode the language command 101 (e.g., a voice command) of a user. The language command 101 may be encoded directly, and/or the language command 101 may be converted into text and then encoded. 2) The visual model 114: may extract visual features from a scene image of an application robot. The visual features may include high-level and low-level visual features. The low-level visual features may include global visual features and local visual features. For example, information regarding a current third timepoint RGB image 102 observation may be encoded into visual tokens (e.g., high-level visual features), class tokens (e.g., global visual features), and register tokens (e.g., local visual features). 3) The LLM 116: may generate reasoning hidden features and cognitive hidden features by combining visual tokens with encoded language commands. 4) The action model selector 120: may generate an evaluation weight of an action type based on reasoning hidden features, and input the generated evaluation weight to the DAM 130. 5) The DAM 130: may dynamically execute different action models and predict temporal action sequences by combining visual class tokens and/or register tokens with cognitive hidden features of a vision-language model (VLM).

For example, a movement such as an arm movement 140 may be executed by the arm movement model (e.g., the first model) 132, and a movement such as a gripper manipulation 150 may be executed by the gripper manipulation model (e.g., the second model) 134.

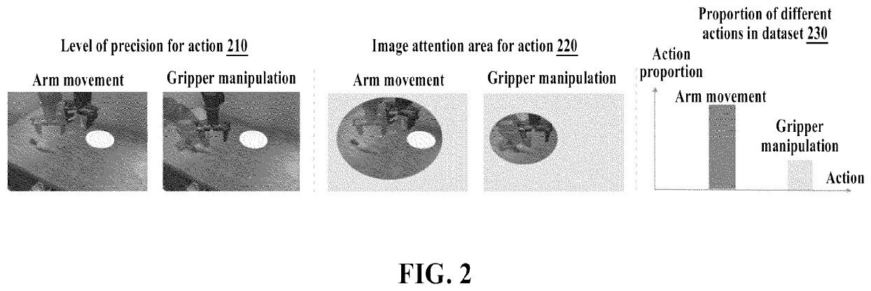

FIG. 2 illustrates an analysis of the difference between an arm movement and a gripper manipulation of a robot according to one or more embodiments.

As shown in FIG. 2, a detailed analysis of an existing robot action process may reveal the following differences between an arm movement and a gripper manipulation during robot manipulation.
1) Level of precision for action 210: for example, in a task of placing a carrot on a plate, a movement of the robot arm may be relatively free and may reach the carrot through an arbitrary path. In comparison, the gripper manipulation for picking up a carrot may not be flexible and may be implemented using a precise gripping posture.
2) Image attention area for action 220: the arm movement may be implemented using more global attention, while the gripper manipulation may be implemented using more local attention.
3) Proportion of different actions in a dataset 230: compared to the gripper manipulation, the arm movement may occupy several times more proportion in the dataset (e.g., may occupy a greater proportion of the dataset).

Based on these differences, the present disclosure proposes a VLM-based DAM (DAM-VLA) framework. The framework of one or more embodiments may dynamically combine unique reasoning capabilities of the VLM with precise manipulation capabilities of a diffusion motion model. For example, the present disclosure may use the unique reasoning capabilities of the VLM to dynamically distinguish between different action models, e.g., the arm movement model 132 and the gripper manipulation model 134, and then use the corresponding action models to complete specific and precise actions. The main actions may be as follows:
1) The disclosure proposes an action model selector (e.g., a selection module). The action model selector may learn weights using unique reasoning capabilities of the VLM, thereby dynamically inferring different action types.
2) The present disclosure proposes a DAM. The DAM may combine high-level reasoning information from the VLM and low-level details from the visual model 114 into an action model. Importantly, the disclosure may generate different visual tokens for different action models, e.g., the arm movement model 132 and the gripper manipulation model 134. For example, the arm movement model 132 may focus more on global visual features, while the gripper manipulation model 134 may focus more on local visual features.
3) The present disclosure of one or more embodiments may generate a dynamic action integration scheme by combining trajectory weights with action block weights, thereby enabling more robust and accurate dynamic distinction between the arm movement model 132 and the gripper manipulation model 134.
4) In a Simple Efficient Robot Learning (SIMPLER) environment, the DAM-VLA method of one or more embodiments may achieve optimal average performance compared to a typical optimal VLA method with respect to the WidowX robot and the Google robot, and at the same time, the DAM-VLA method of one or more embodiments may demonstrate more stable manipulation capabilities in situations where a robot has detailed manipulation, various posture changes, and objects and environments change.

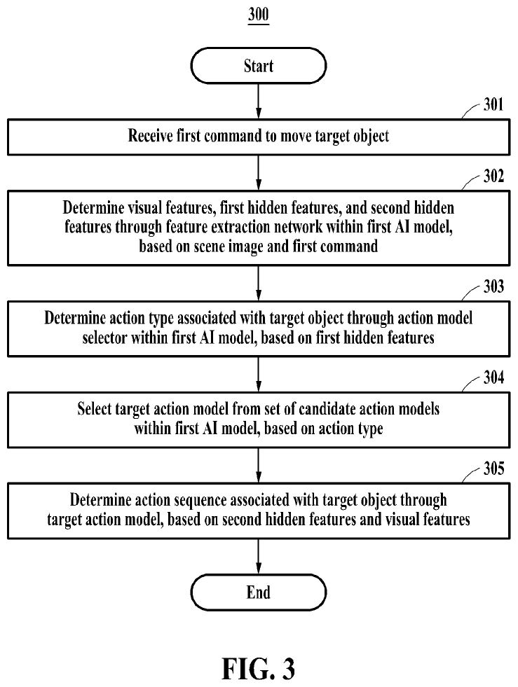

FIG. 3 illustrates an example of a method executed by an electronic device according to one or more embodiments.

Referring to FIG. 3, a process 300 of a method executed by an electronic device may include the following operations. Although one or more of the operations of FIG. 3 are illustrated as being performed sequentially, one or more of the operations may be performed in a different order, one or more of the operations may be omitted, two or more of the operations may be performed in parallel or simultaneously, and/or other operations may be additionally performed without departing from the spirit and scope of the described embodiments.

In operation 301, the process 300 may receive a first command to move a target object.

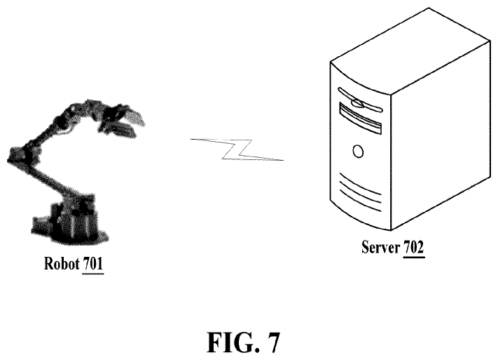

In the one or more embodiments, an execution subject of the method executed by the electronic device may be a server and/or a robot illustrated in FIG. 7. The server may transmit a trained robot action prediction model to the robot, and the robot may execute operations 302 to 305. Additionally or alternatively, the server may execute operations 302 to 305 locally.

The robot may receive the first command related to the object to be moved transmitted by a user via a voice and/or remote control signal. The first command may be a language command or a command of some other type. For example, for the command “Place the carrot on the plate”, the robot may determine what action to perform. When the server executes operations 302 to 305, the robot may transmit the language command to the server. The server may notify a third-party camera to acquire a scene image of the object. The scene image may not necessarily be triggered and collected by the first command, and may be collected in real time. The server may recognize the user's intention based on the language command and determine the target object (e.g., robot, carrot, and/or plate) to be included in the scene image. The server may control the third-party camera to acquire a scene image that includes the target object by adjusting a direction, angle, and distance from the target object. When the robot executes operations 302 to 305, the robot may locally process the language command and acquire a scene image of the object through a notification to a local camera and/or a third-party camera.

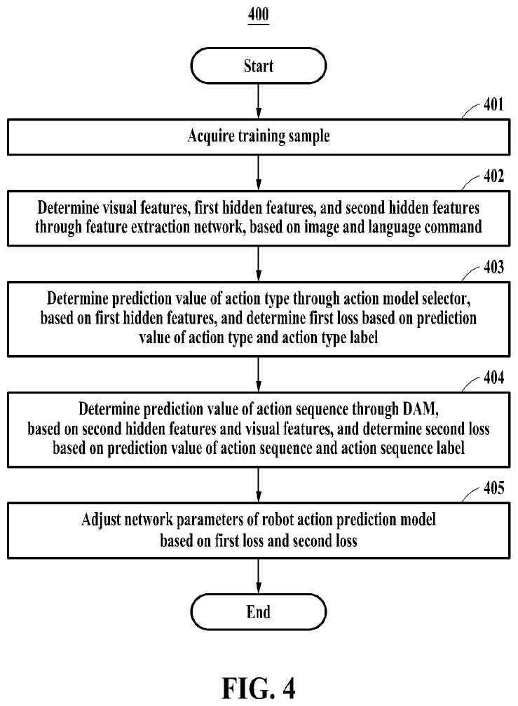

In the one or more embodiments, the robot action prediction model may include a feature extraction network, an action model selector, and a DAM. The robot action prediction model may be trained using a method according to an example embodiment illustrated in FIG. 4 described below. The detailed training process may be referred to in the description of the one or more embodiments of FIG. 4, and a duplicate description thereof is omitted.

In operation 302, the process 300 may determine visual features, first hidden features, and second hidden features through the feature extraction network 110 within the robot action prediction model (the first AI model), based on the scene image and the first command.

In the one or more embodiments, the feature extraction network 110 may be a neural network for extracting features from the first command and the scene image. The features may include visual features, first hidden features, and second hidden features.

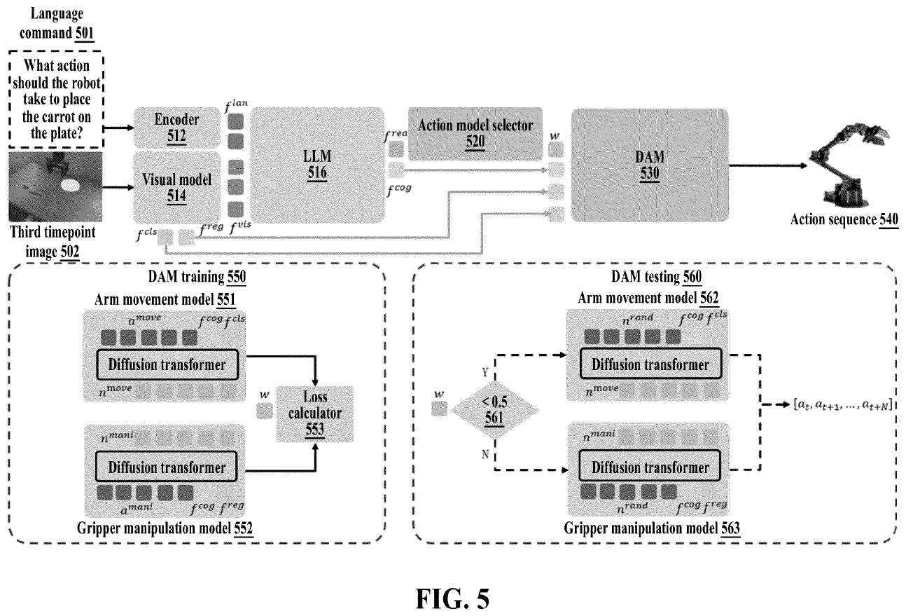

FIG. 5 illustrates an example of an application scenario of a method executed by an electronic device according to one or more embodiments.

As illustrated in FIG. 5, a visual model 514 (e.g., a VLM) may process an input of a third timepoint image 502 (e.g., an RGB image of a third timepoint) into a single set of perceptual tokens (e.g., visual features). For example, the visual features may include class tokens f^{cls} and register tokens f^{reg} as well as visual tokens f^{vis}. The visual model 514 may include powerful visual transformers such as a Self-Distillation with No Labels version 2 (DINOv2) and a Sigmoid loss for Language-Image Pre-training (SigLIP), which may be pre-trained on internet-scale image data to capture rich low-level visual features and advanced semantic understanding of observations. At each time step t, an image observation result oₜ may be input to DINOv2 and SigLIP, and two downsampled feature maps

$${f}_{t}^{DINO} and {f}_{t}^{Sig}$$

may be generated. These feature maps may be concatenated in the channel dimension direction and then sequenced through a linear projection layer to be transformed into a single set of visual perceptual tokens. The set may include a visual token f^{vis}=[v₁, v₂, . . . , v_{NV}], class token f^{cls}, and register token f^{reg}.

An LLM 516 may integrate visual information with a language command 501 and produce reasoning tokens. Here, an LLM Meta AI version 2 (LLAMA-2) model may be used as a backbone model. The language command 501 may be transformed into a single set of language tokens f^{lan}=[l₁, l₂, . . . , l_{NZ}] through a LLAMA-2 module of an encoder 512. These language tokens f^{lan} may then be concatenated with the visual token f^{vis} and additional learnable reasoning tokens, and the language tokens f^{lan} and the visual token f^{vis} or a result of the concatenating may be processed by an LLM 516 using a causal attention mechanism. Cognitive hidden features f^{cog} (e.g., the second hidden features) and reasoning hidden features f^{rea} (e.g., the first hidden features) may be output as a result of the processing by the LLM 516. The reasoning hidden features f^{rea} and the cognitive hidden features f^{cog} may be acquired from hidden features of the second transformer layer and hidden features of the last transformer layer of the LLM 516, respectively. The cognitive hidden features f^{cog} may predict (or may be used to predict) the conditions of an action as a subsequent action model. The reasoning hidden features f^{rea} may be features of a subsequent action selection module that may dynamically infer (or may be used to dynamically infer) different types of actions.

In operation 303, the process 300 may determine an action type associated with the target object through a selection module (e.g., an action model selector 520) within the robot action prediction model (e.g., the first AI model), based on the first hidden features.

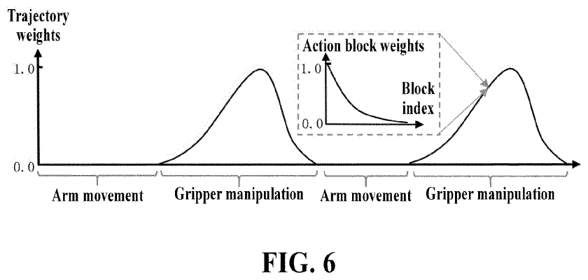

In the one or more embodiments, the action model selector 520 may be a classifier. As illustrated in FIG. 5, the action model selector 520 may estimate a weight w (e.g., a prediction value of an action type) using the reasoning capability of the VLM and the self-supervised learning of a ground truth weight (e.g., an action type label ŵ∈(0,1)) and input the weight w to a DAM 530 to dynamically execute various action models such as arm movement models 551 and 562 and gripper manipulation models 552 and 563 of the DAM 530. The ground truth weight ŵ may be acquired depending on a state of the robot gripper. When the state of the robot gripper changes from an open state to a closed state or from a closed state to an open state, the action of the robot may transition from an arm movement ŵ=0 to a gripper manipulation ŵ=1. An example of a detailed determination process of ŵ is further described below with reference to the dynamic action integration scheme of FIG. 6. In order to demonstrate the reasoning capability of the VLM, the reasoning hidden features f^{rea} input from the VLM to the action model selector 520 may output an estimated weight w after being processed through a fully connected layer and a normalization layer.

The method of the disclosure may determine an action type associated with a target object based on the estimated weight w. For example, when w is less than a first threshold value, the action type may be determined to be an arm movement, and when w is greater than or equal to the first threshold value, the action type may be determined to be a gripper manipulation. The first threshold value may be preset or may be an empirical or simulated value, and may be set to “0.5”, for example.

In operation 304, the process 300 may select a target action model from a set of candidate action models within the robot action prediction model (e.g., the first AI model), based on the action type.

In the one or more embodiments, the set of candidate action models may include a plurality of pre-trained action models, which each may correspond to an action type.

In the one or more embodiments, the DAM 530 may be a neural network and may predict a series of actions (e.g., action blocks) of a robot. For example, the DAM 530 may include the arm movement models 551 and 562 and the gripper manipulation models 552 and 563. When the action type is an arm movement, the target action model may be selected as the arm movement models 551 and 562. When the action type is a gripper manipulation, the target action model may be selected as the gripper manipulation models 552 and 563. The disclosure may propose a DAM mechanism, wherein the process 300 may relate to a testing (e.g., implementation) operation and a process 400 may relate to a training operation. Each of the arm movement models 551 and 562 and the gripper manipulation models 552 and 563 may be implemented through a diffusion transformer. The diffusion transformer may be a neural network module using a diffusion model principle.

In operation 305, the process 300 may determine an action sequence associated with the target object through the selected target action model, based on the second hidden features and the visual features.

In the one or more embodiments, in a DAM testing operation 560 as illustrated in FIG. 5, the DAM 530 may dynamically execute different action models according to the estimated weight w. A condition determining portion 561 may compare the estimated weight w with the ground truth weight (e.g., “0.5”) to determine whether the condition of the arm movement model 562 or the gripper manipulation model 563 is met.

When a result of the condition determining portion 561 confirms that w is less than “0.5”, the DAM testing operation 560 of the DAM 530 may execute the arm movement model 562 and predict a series of multi-step actions based on the cognitive hidden features f^{c} and global class token f^{cls} extracted from an upper VLM. When a result of the condition determining portion 561 confirms that w is greater than or equal to “0.5”, the DAM testing operation 560 of the DAM 530 may execute the gripper manipulation model 563 and predict a series of multi-step actions based on the cognitive hidden features f^{c} and the global class token f^{cls} extracted from the upper VLM.

In one or more embodiments, the set of candidate action models may include the arm movement model (e.g., a first model) 562 related to an arm movement and the gripper manipulation model (e.g., a second model) 563 related to a gripper manipulation. In addition, the operation 303 of determining the action type associated with the target object through the action model selector 520 within the first AI model based on the first hidden features may include outputting a prediction value of the action type associated with the target object through the action model selector 520 within the first AI model based on the first hidden features, determining the action type to be an arm movement in response to the prediction value being less than a first threshold value, and determining the action type to be a gripper manipulation in response to the prediction value being greater than or equal to the first threshold value. The process 300 of one or more embodiments may improve the accuracy of action prediction by predicting an action by selecting one of a plurality (e.g., two) DAMs based on the action type.

In one or more embodiments, the visual features may include global visual features and local visual features. Additionally, the determining of the action sequence associated with the target object through the target action model based on the second hidden features and the visual features may include, in response to the action type being an arm movement, determining an action sequence associated with the target object through the arm movement model (e.g., the first model) 562, based on the second hidden features and the global visual features, and/or, in response to the action type being a gripper manipulation, determining the action sequence associated with the target object through the gripper manipulation model (e.g., the second model) 563, based on the second hidden features and the local visual features.

In addition to using the cognitive hidden features f^{cog} extracted from the upper VLM as a condition, the two action models may also input sub-visual features as a condition. Since the two models may focus on different attention areas of an image (as illustrated in FIG. 2), the disclosure may input different visual features. Since the arm movement model 562 may be implemented using more global attention, the disclosure may input the global class token f^{cls} (e.g., global visual features) as a condition. Since the gripper manipulation model 563 may be implemented using more local attention, the disclosure may input the register token f^{reg} (e.g., local visual features) as a condition.

In one or more embodiments, the visual features may include global visual features (e.g., the global class token f^{cls}) and local visual features (e.g., the register token f^{reg}). Additionally, the determining of the action sequence associated with the target object through the target action model based on the second hidden features and the visual features may include, in response to the action type being an arm movement, determining an action sequence associated with the target object through the arm movement model (e.g., the first model) 562, based on random noise, the second hidden features, and the global visual features, or, in response to the action type being a gripper manipulation, determining the action sequence associated with the target object through the gripper manipulation model (e.g., the second model) 563, based on random noise, the second hidden features, and the local visual features.

In actual application, the input of the action model may further include random noise n^{rand} The DAM 530 may remove noise and output a prediction value of the action sequence.

In one or more embodiments, the feature extraction network may include an encoder 512, the visual model 514, and the LLM 516. In addition, the determining of the visual features, the first hidden features, and the second hidden features through the feature extraction network within the first AI model based on the scene image and the first command may include determining language features through the encoder 512, based on the first command, determining first visual features (e.g., the visual tokens f^{vis}) and second visual features (e.g., the global class token f^{cls} and the register tokens f^{reg}) through the visual model 514, based on the scene image, and determining the first hidden features and the second hidden features through the LLM 516, based on the first visual features and the language features. Here, the first visual features may be used to represent a basic structure and/or local information of the scene image, and the second visual features may be used to represent semantic information of the scene image.

As illustrated in FIG. 5, the visual model 514 may process the third timepoint RGB image (e.g., the third timepoint image 502) input into a single set of perceptual tokens (e.g., visual features). For example, the visual features may include class tokens f^{cls} and register tokens f^{reg} as well as visual tokens f^{vis}. The visual model 514 may include powerful visual transformers such as DINOv2 and SigLIP, which may be pre-trained on internet-scale image data to capture rich low-level visual features and advanced semantic understanding of observations. At each time step t, an image observation result oₜ may be input to DINOv2 and SigLIP, and two downsampled feature maps

$${f}_{t}^{DINO} and {f}_{t}^{Sig}$$

may be generated. Next, the visual model 514 may be sequenced by concatenating the feature maps in the channel dimension direction and then passing them through a linear projection layer to be transformed into a single set of visual perceptual tokens. The set of visual perceptual tokens may include visual tokens f^{vis}=[v₁, v₂, . . . , v_{NV}], class tokens f^{cls}, and register tokens f^{reg}.

The LLM 516 may integrate visual information with the language command 501 and produce reasoning tokens. Here, the LLAMA-2 model may be used as a backbone model. The language command 501 may be transformed into a single set of language tokens f^{lan}-[l₁, l₂, . . . , l_{NL}] through a LLAMA-2 module. These tokens f^{lan} may then be concatenated with the visual tokens f^{vis} and additional learnable reasoning tokens, and processed by the LLM 516 using a causal attention mechanism. Finally, the LLM 516 may output cognitive hidden features f^{cog} (e.g., the second hidden features) and reasoning hidden features f^{rea} (e.g., the first hidden features).

In one or more embodiments, the first hidden features and the second hidden features may be acquired from hidden features of the second transformer layer and hidden features of the last transformer layer of the LLAMA-2 model, respectively, and the second transformer layer may be used for action selection and the last transformer layer may be used for action estimation.

f^{rea} and f^{cog} may be acquired from the hidden features of the second transformer layer and the hidden features of the last transformer layer of the LLM 516, respectively. The cognitive hidden features f^{cog} may predict the conditions of an action as a subsequent action model. The reasoning hidden features f^{rea} may be features of a subsequent action selection module that may dynamically infer different types of actions.

In one or more embodiments, the determining of the action sequence associated with the target object through the target action model based on the second hidden features and the visual features may include determining the action sequence associated with the target object through the target action model, based on the second hidden features and the second visual features.

As illustrated in FIG. 5, the action model selector 520 may use the reasoning capability of the VLM and self-supervised learning of the ground truth weight (e.g., the action type label ŵ∈(0,1)) to estimate the weight w (e.g., a prediction value of the action type) and input w to the DAM 530. The DAM 530 may select and dynamically execute various action models, such as the arm movement model 562 and the gripper manipulation model 563, depending on w. The ground truth weight w may be acquired depending on a state of the robot gripper. When the state of the robot gripper changes from an open state to a closed state or from a closed state to an open state, the action of the robot may transition from the arm movement ŵ=0 to the gripper manipulation ŵ=1. An example of a detailed determination process of w is further described below with reference to the dynamic action integration scheme of FIG. 6. In order to demonstrate the reasoning capability of the VLM, the reasoning hidden features f^{rea} input from the VLM to the action model selector 520 may output the estimated weight w after being processed through a fully connected layer and a normalization layer.

In one or more embodiments, the feature extraction network including the encoder 512, the visual model 514, and the LLM 516 may include a LLAMA-2 model. The LLAMA-2 model may be used as a backbone network. The LLAMA-2 model may fuse voice features and visual features to acquire the cognitive hidden features f^{cog} and reasoning hidden features freq.

In one or more embodiments, the feature extraction network may include a DINOv2 model and a SigLIP model. The visual model 514 within the feature extraction network may include powerful visual transformers such as DINOv2 and SigLIP, which may be pre-trained on internet-scale image data to capture rich low-level visual features and advanced semantic understanding of observations.

FIG. 4 illustrates an example of a method executed by an electronic device according to one or more embodiments.

FIG. 4 illustrates a process 400 of a method executed by an electronic device, and the method may include the following operations. Although one or more of the operations of FIG. 4 are illustrated as being performed sequentially, one or more of the operations may be performed in a different order, one or more of the operations may be omitted, two or more of the operations may be performed in parallel or simultaneously, and/or other operations may be additionally performed without departing from the spirit and scope of the described embodiments.

In operation 401, the process 400 may acquire a training sample.

In the one or more embodiments, an execution subject (e.g., the server shown in FIG. 7) of a method of training a robot action prediction model may acquire a training sample set through various schemes. For example, the execution subject may acquire an existing training sample set stored in a database server from the database server via a wired or wireless connection. For example, a user may collect training samples via a robot. In this example, the execution subject may receive the training samples collected by the robot and store the training samples locally to generate a training sample set.

The training sample set may include at least one training sample. The training samples may include images, language commands, action type labels, and action sequence labels.

The third timepoint image 502 may be an image including a robot and a manipulation object at a third timepoint. The image may be a planar image or a stereoscopic image including depth information. Additionally, the image may be a color image (e.g., a red, green, blue (RGB) photograph) and/or a grayscale image. The format of the image is not limited by the disclosure, and any format that the execution subject may read and recognize, such as joint photographic experts group (jpg), bitmap (BMP), and/or a lossless compression format such as a RAW image format, may be possible.

In one or more embodiments, the language command 501 may be voice data or data acquired by converting voice data into text.

In one or more embodiments, the action type label may be referred to as the ground truth of the action type, where the action type may include an arm movement and a gripper manipulation.

In one or more embodiments, the action sequence label may refer to a robot's actual action space aₜ=[Δ{x}, Δθ, grip].

The process 400 may select a training sample from the training sample set and execute training operations 402 to 405. The manner of selecting the training sample and the number of training samples selected are not limited by the disclosure. For example, at least one training sample may be randomly selected, or a training sample with high image clarity (e.g., high resolution) may be selected.

In operation 402, the process 400 may determine visual features, first hidden features, and second hidden features through a feature extraction network, based on the third timepoint image 502 and the language command 501.

In the one or more embodiments, the feature extraction network may be a neural network, and may be used to extract features from the language command 501 and the third timepoint image 502. The features may include the visual features, first hidden features, and second hidden features.

In operation 403, the process 400 may determine a prediction value of an action type through the action model selector 520, based on the first hidden features, and determine a first loss based on the prediction value of the action type and the action type label. The process 400 may determine the first loss based on the prediction value of the action type and the action type label as in Equation 1 below, for example, and may refer to the first loss as a classification loss L_{class}.

An estimated weight w may be supervised by the cross entropy loss below.

L_{class}=∥−(ŵ log(w)+(1−ŵ)log(1−w))∥¹ Equation 1:

The first loss may be applied to other loss functions as well, but is not limited thereto.

In operation 404, the process 400 may determine a prediction value of an action sequence through the DAM 530, based on the second hidden features and the visual features, and determine a second loss based on the prediction value of the action sequence and the action sequence label.

In a DAM training operation 550, the DAM 530 may be trained using a ground truth weight ŵⁿ to perform targeted learning for the arm movement model 551 and the gripper manipulation model 552. A more detailed description of the ŵⁿ is provided in the dynamic action integration scheme of FIG. 6.

The DAM 530 may output a prediction value of the action sequence based on the second hidden features and the visual features. The DAM 530 may determine the second loss based on the difference between the prediction value of the action sequence and the action sequence label. The second loss may adopt a loss function such as L2.

In addition to using the cognitive hidden features f^{cog} extracted from the upper VLM as a condition, the two action models may also input sub-visual features as a condition. Since the two models may focus on different attention areas of an image (as illustrated in FIG. 2), the disclosure may input different visual features. Since the arm movement model 551 may be implemented using more global attention, the disclosure may input class tokens f^{cls} as a condition. Since the gripper manipulation model 552 may be implemented using more local attention, the disclosure may input register tokens f^{reg} as a condition. The losses of the two models may be supervised independently.

When following a reinforcement learning strategy based on a diffusion model, the determination of the second loss may be as expressed by Equation 2 below, for example.

$${L}_{move} = {‖ {n}_{i}^{move} - {\hat{n}}^{move} ‖}_{\sum {\hat{w}}^{n}}^{2} \qquad Equation 2$$

$${L}_{mani} = {‖ {n}_{i}^{mani} - {\hat{n}}^{mani} ‖}_{\sum 1 - {\hat{w}}^{n}}^{2}$$

Here, ∥⋅∥_{Σ} denotes a Mahalanobis distance, which may weigh an error term according to the ground truth weight ŵₙ.

$${n}_{i}^{move} and {n}_{i}^{mani}$$

denote noise estimations for a noisy action sequence at an i-th denoising operation of the arm movement model 551 and the gripper manipulation model 552, respectively, and \hat{n}^{move} and \hat{n}^{mani} denote randomly generated ground truths corresponding to the arm movement model 551 and the gripper manipulation model 552, respectively. Additionally, inputs of the arm movement model 551 and the gripper manipulation model 552 may each include actions a^{move} and a^{mani} containing noise. a^{move} may be determined from ground truth noise

$${n}_{i}^{move}$$

and a ground truth action â. a^{mani} may be determined from a ground truth noise

$${n}_{i}^{mani}$$

and a ground truth action â.

The weighted sum of an action loss Lₘₒᵥₑ and a manipulation loss Lₘₐₙᵢ may be used as the second loss.

The total loss may be the weighted loss of the action loss Lₘₒᵥₑ, the manipulation loss Lₘₐₙᵢ, and a classification loss L_{class}, as expressed by Equation 3 below, for example.

L=w1*Lₘₒᵥₑ+w2*Lₘₐₙᵢ+w3*L_{class} Equation 3:

Here, w1, w2, and w3 denote hyperparameter weights, which may be set to “1.0”, “1.0”, and “0.0001”, respectively.

In operation 405, the process 400 may adjust network parameters of a robot action prediction model based on the first loss and the second loss.

In the one or more embodiments, in the DAM training operation 550 as illustrated in FIG. 5, the arm movement model 551 and the gripper manipulation model 552 may be dynamically executed, and the loss may be determined in the same manner as Equation 2 and Equation 3 described above via a loss determiner 553.

In the one or more embodiments, the process 400 may determine the total loss based on the first loss and the second loss. When a plurality of training samples is selected, the execution subject may determine that the training of the robot action prediction model is complete when the total loss of each training sample reaches a target value. In another example, the execution subject may determine a proportion of samples among the selected samples for which the total loss reaches a target value. When the proportion reaches a preset sample proportion (e.g., 95%), the training of the robot action prediction model may be considered complete.

In the one or more embodiments, when the execution subject determines that training of the robot action prediction model is complete, the operations of the process 300 may be executed. When the execution subject determines that the training of the robot action prediction model is not complete, the relevant parameters of the feature extraction network, the action model selector 520, and the DAM 530 within the robot action prediction model may be adjusted. For example, the weights of each convolutional layer within the robot action prediction model may be modified using backpropagation techniques. Additionally, the training operations (operations 402 to 405) may be continued by returning to operation 401 and reselecting a training sample from the training sample set.

Here, the manner of selecting the training samples is not limited by the disclosure. For example, when there are multiple training samples in the training sample set, the execution subject may select a training sample that has not yet been selected.

When the execution subject determines that the training of the robot action prediction model is complete, the robot action prediction model may be applied to testing.

Optionally, the execution subject may store the generated robot action prediction model locally or transmit the generated robot action prediction model to a robot or database server.

In one or more embodiments, the action type label may be configured in the following manner. The action model selector 520 may acquire trajectory weights by combining Gaussian distributions, acquire action block weights through exponential decay, and use the product of the trajectory weights and the action block weights as the action type label.

In order to dynamically distinguish the arm movement model 551 and the gripper manipulation model 552 more robustly and accurately, the disclosure may include a dynamic action integration scheme. The main objective of this scheme is to consider a process by which a network learns different actions from both a global and a local perspective. The global perspective may consider the entire trajectory of each task, while the local perspective may consider each predicted action block. For example, the disclosure may use a combined Gaussian distribution

$${\hat{w}}^{t} = N ( u , {σ}_{l}^{2} , {σ}_{r}^{2} )$$

with respect to a trajectory weight ŵ^{t}.

In one or more embodiments, the combined Gaussian distribution may include the left portion of a first Gaussian distribution and the right portion of a second Gaussian distribution having the same average value but different variances. The variance of the left portion may be greater than the variance of the right portion.

FIG. 6 illustrates an example of a dynamic action integration scheme according to one or more embodiments.

Referring to FIG. 6, the arm movement model 132, 551, or 562 and the gripper manipulation model 134, 552, or 563 may have the same average value u, and the average value u may be determined by a timepoint at which opening and closing of a gripper occurs. However, the variances

$${σ}_{l}^{2} and {σ}_{r}^{2}$$

are different, and the gripper manipulation model 134, 552, or 563 may be more important before the change of the opening and closing of the gripper, so σₗ may be set to “9” and σᵣ may be set to “3”. Gaussian distribution

$$N ( u , {σ}_{l}^{2} )$$

may take the left portion, and Gaussian distribution

$$N ( u , {σ}_{r}^{2} )$$

may take the right portion. Afterwards, an exponential decay scheme

$${\hat{w}}_{i}^{a} = {e}^{- i}$$

may be configured with respect to an action block weight ŵ^{a}. i denotes an index of the action block. By combining these two aspects, a final ground truth weight ŵⁿ=ŵ^{t}*ŵ^{a} may be acquired, as shown in FIG. 6. In addition, w is determined through ŵⁿ, and when ŵⁿ is greater than “0.5”, ŵ may be equal to “1”, and when ŵⁿ is less than 0.5, ŵ may be equal to “0”.

In one or more embodiments, the feature extraction network 110 may include the encoder 112 or 512, the visual model 114 or 514, and the LLM 116 or 516. Additionally, the determining of visual features, first hidden features, and second hidden features through the feature extraction network 110, based on an image and a language command may include determining language features through the encoder 112 or 512, based on the language command, determining first visual features and second visual features through the visual model 114 or 514, based on the image, and determining the first hidden features and the second hidden features, based on the first visual features and the language features.

The first visual features may be provided as high-level features to the LLM 116 or 516, and the second visual features may be provided as low-level features to the DAM 130 or 530. The first visual features may be used to represent a basic structure and local information of the image, and the second visual features may be used to represent semantic information of the image.

The LLM 116 or 516 may extract the first hidden features and the second hidden features from an intermediate layer by fusing the first visual features with the language features. The first hidden features may be used to determine which DAM to select, and the second hidden features may be used to predict an action of the robot.

In one or more embodiments, the determining of the prediction value of the action sequence through the DAM 130 or 530, based on the second hidden features and the visual features, may include outputting the prediction value of the action sequence through the DAM 130 or 530, based on the second hidden features and the second visual features.

The DAM 130 or 530 may predict an action of the robot by fusing the second hidden features with the second visual features.

In one or more embodiments, the second visual features may include global visual features and local visual features, and the DAM 130 or 530 may include the arm movement model 132, 551, or 562 and the gripper manipulation model 134, 552, or 563. In addition, the determining of the prediction value of the action sequence through the DAM 130 or 530, based on the second hidden features and the second visual features, may include determining a prediction value of an arm movement through the arm movement model 132, 551, or 562, based on the second hidden features and the global visual features, and inputting the second hidden features and the local visual features into the gripper manipulation model 134, 552, or 563 to determine a prediction value of a gripper manipulation.

Since the arm movement model 132, 551, or 562 may be implemented using more global attention, the disclosure may input class tokens f^{cls} as a condition. Since the gripper manipulation model 134, 552, or 563 may be implemented using more local attention, the disclosure may input register tokens f^{reg} as a condition.

In one or more embodiments, the determining of the second loss based on the prediction value of the action sequence and the action sequence label may include determining an action loss based on the difference between the prediction value of the arm movement and the action sequence label, determining a manipulation loss based on the difference between the prediction value of the gripper manipulation and the action sequence label, and determining a weighted sum of the action loss and the manipulation loss as the second loss.

In one or more embodiments, the training process of the disclosure may minimize loss by directly using the action sequence label as a supervisory signal to supervise training of prediction values of arm movements and prediction values of gripper manipulations. That is, a predicted action may be closest to the actual action.

In one or more embodiments, the second visual features may include global visual features and local visual features, and the DAM 130 or 530 may include the arm movement model 132, 551, or 562 and the gripper manipulation model 134, 552, or 563. In addition, the determining of the prediction value of the action sequence through the DAM 130 or 530, based on the second hidden features and the second visual features, may include determining a prediction value of an arm movement including noise through the arm movement model 132, 551, or 562, based on a predetermined noise, the second hidden features, and the global visual features, or predicting a prediction value of a gripper manipulation including noise through the gripper manipulation model 134, 552, or 563, based on the noise, the second hidden features, and the local visual features.

The training process of the disclosure may incrementally add Gaussian noise to the action sequence, ultimately acquiring a single complete noise state. By training a neural network (e.g., a U-Net), the noise state may be gradually denoised and the original action sequence may be restored. At the execution stage, a final action sequence may be generated by starting from a noise state and performing incremental denoising using the trained network.

In one or more embodiments, the determining of the second loss based on the prediction value of the action sequence and the action sequence label may include superimposing noise on the action sequence label to generate a noisy action label, determining a noise action loss based on the difference between a prediction value of an arm movement including noise and the noisy action label, determining a noise manipulation loss based on the difference between a prediction value of a gripper manipulation including noise and the noisy action label, and determining a weighted sum of the noise action loss and the noise manipulation loss as the second loss. When Gaussian noise is added, the losses of the arm movement model 132, 551, or 562 and the gripper manipulation model 134, 552, or 563 may be supervised independently, as expressed by Equation 2 described above.

In one or more embodiments, the feature extraction network 110 may include a LLAMA-2 model. The LLAMA-2 model may be used as a backbone network. The LLAMA-2 model may fuse voice features and visual features to acquire the cognitive hidden features f^{cog} and reasoning hidden features f^{rea}.

In one or more embodiments, the feature extraction network 110 may include a DINOv2 model and a SigLIP model. The visual model 114 or 514 within the feature extraction network 110 may include powerful visual transformers such as DINOv2 and SigLIP, which may be pre-trained on internet-scale image data to capture rich low-level visual features and advanced semantic understanding of observations.

In one or more embodiments, the first loss may be a cross entropy loss and the second loss may be an L2 loss. Since the action model selector 120 or 520 may implement a classification function, it may be more effective to apply the cross entropy loss. Since the DAM 130 or 530 may solve a regression problem, it may be more effective to apply the L2 loss.

The method provided in the above-described embodiment of the disclosure may propose the action model selector 120 or 520. The action model selector 120 or 520 may learn weights using the unique reasoning capability of a VLM, thereby dynamically inferring different action types. Additionally, the disclosure may propose the DAM 130 or 530. The DAM 130 or 530 may combine high-level reasoning information from the VLM and low-level details from the visual model 114 or 514 into the DAM 130 or 530. Furthermore, the disclosure may generate different visual tokens for different action models, e.g., the arm movement model 132, 551, or 562 and the gripper manipulation model 134, 552, or 563. For example, the arm movement model 132, 551, or 562 may focus more on global visual features, while the gripper manipulation model 134, 552, or 563 may focus more on local visual features.

FIG. 7 illustrates an example of a structure of a robot system according to one or more embodiments.

Referring to FIG. 7, the robot system may include a robot 701 and a server 702, which may be connected to each other through a wireless network. The robot 701 may process a received first command locally or transmit the received first command to the server 702 for processing. The server 702 may be configured to execute the method according to the process 300 or the process 400, and may output an action sequence and transmit the action sequence to the robot 701. The robot 701 may be configured to receive an action sequence, and may complete an action according to the action sequence.

One or more embodiments of the disclosure may further provide an electronic device, the electronic device including a processor, and optionally, a transceiver and/or memory coupled to the processor, the processor being configured to execute operations of the method provided by any one embodiment of the disclosure.

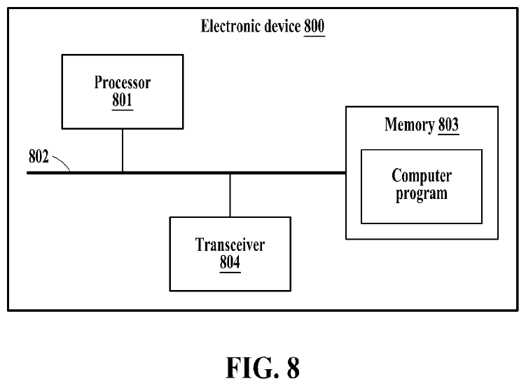

FIG. 8 illustrates an example of a structure of a computer system of an electronic device according to one or more embodiments.

As illustrated in FIG. 8, an electronic device 800 may include a processor 801 (e.g., one or more processors) and a memory 803 (e.g., one or memories). The processor 801 and the memory 803 may be connected to each other, for example, through a bus 802. Optionally, the electronic device 800 may further include a transceiver 804, which may be used for data exchange, such as transmission of data and/or reception of data between the electronic device 800 and another electronic device. In actual applications, the transceiver 804 is not limited to one, and the structure of the electronic device 800 does not constitute a limitation to the embodiments of the disclosure. Optionally, the electronic device 800 may be a first network node, a second network node, and/or a third network node.

The processor 801 may be a CPU, a general-purpose processor, a digital signal processor (DSP), an application-specific integrated circuit (ASIC), a field programmable gate array (FPGA) or another programmable logic device, transistor logic device, hardware component, and/or any combination thereof. Various example logic blocks, modules, and circuits described herein may be implemented or executed. The processor 801 may also be a combination that realizes computing functions including, for example, a combination of one or more microprocessors or a combination of a DSP and a microprocessor.

The bus 802 may include a path for transmitting information between the above-described components. The bus 802 may be a peripheral component interconnect (PCI) bus or an extended industry standard architecture (EISA) bus. The bus 802 may be classified into an address bus, a data bus, and a control bus. For convenience of illustration, only one bold line is shown in FIG. 8, but there may not be only one bus or only one type of bus.

The memory 803 may be read-only memory (ROM) or another type of static storage device capable of storing static information and instructions, random access memory (RAM) or another type of dynamic storage device capable of storing information and instructions, electrically erasable programmable read-only memory (EEPROM), a CD-ROM or another optical disc storage, optical disc storage (including compressed optical discs, laser discs, optical discs, digital versatile discs, Blu-ray discs, and the like), disc storage media, other magnetic storage devices, and/or any other medium that may be used to carry or store a computer program and that may be read by a computer, but is not limited thereto.

The memory 803 may be used to store a computer program for executing one or more embodiments of the disclosure and may be controlled by the processor 801. The processor 801 may be configured to execute a computer program stored in the memory 803 to implement the operations of the method described above. For example, the memory 803 may be or include a non-transitory computer-readable storage medium storing instructions that, when executed by the processor 801, configure the processor 801 to perform any one, any combination, or all of the operations and/or methods disclosed herein with reference to FIGS. 1-8.

The action model selectors, robots, servers, electronic devices, processors, memories, transceivers, action model selector 120, action model selector 520, robot 701, server 702, electronic device 800, processor 801, memory 803, and transceiver 804 described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-8 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RW, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
determining visual features, first hidden features, and second hidden features through a feature extraction network within a first artificial intelligence (AI) model, based on a scene image and a first command to move a target object;
determining an action type associated with the target object through an action model selector within the first AI model, based on the first hidden features;
selecting a target action model from a set of candidate action models within the first AI model, based on the action type; and
determining an action sequence associated with the target object through the target action model, based on the second hidden features and the visual features.

2. The method of claim 1, wherein the set of candidate action models comprises a first model associated with an arm movement and a second model associated with a gripper manipulation.

3. The method of claim 2, wherein the determining of the action type comprises:
outputting a prediction value of the action type associated with the target object through the action model selector within the first AI model, based on the first hidden features;
determining the action type to be an arm movement, in response to the prediction value being less than a first threshold value; and
determining the action type to be a gripper manipulation, in response to the prediction value being greater than or equal to the first threshold value.

4. The method of claim 2, wherein
the visual features comprise global visual features and local visual features, and
the determining of the action sequence comprises either one of:
determining the action sequence associated with the target object through the first model, based on the second hidden features and the global visual features, in response to the action type being an arm movement; and
determining the action sequence associated with the target object through the second model, based on the second hidden features and the local visual features, in response to the action type being a gripper manipulation.

5. The method of claim 2, wherein
the visual features comprise global visual features and local visual features, and
the determining of the action sequence comprises either one of:
determining the action sequence associated with the target object through the first model, based on random noise, the second hidden features, and the global visual features, in response to the action type being an arm movement; and
determining the action sequence associated with the target object through the second model, based on random noise, the second hidden features, and the local visual features, in response to the action type being a gripper manipulation.

6. The method of claim 1, wherein
the feature extraction network comprises an encoder, a visual model, and a large language model (LLM), and
the determining of the visual features, the first hidden features, and the second hidden features comprises:
determining language features through the encoder, based on the first command;
determining first visual features and second visual features through the visual model, based on the scene image; and
determining the first hidden features and the second hidden features through the LLM, based on the first visual features and the language features.

7. The method of claim 6, wherein
the first visual features are used to represent a basic structure and/or local information of the scene image, and
the second visual features are used to represent semantic information of the scene image.

8. The method of claim 6, wherein
the LLM is an LLM Meta AI version 2 (LLAMA-2) model,
the first hidden features are acquired from hidden features of a second transformer layer of the LLAMA-2 model,
the second hidden features are acquired from hidden features of a last transformer layer,
the second transformer layer is used for action selection, and
the last transformer layer is used for action estimation.

9. The method of claim 6, wherein the determining of the action sequence comprises determining the action sequence associated with the target object through the target action model, based on the second hidden features and the second visual features.

10. The method of claim 1, wherein the feature extraction network comprises a Self-Distillation with No Labels version 2 (DINOv2) model and a Sigmoid loss for Language-Image Pre-training (SigLIP) model.

11. The method of claim 1, further comprising:
determining a first loss based on a prediction value of the action type and an action type label;
determining a second loss based on a prediction value of the action sequence and an action sequence label; and
adjusting network parameters of the first AI model based on the first loss and the second loss.

12. A robot system comprising:
a server configured to determine visual features, first hidden features, and second hidden features through a feature extraction network within a first artificial intelligence (AI) model, based on a scene image and a first command to move a target object, determine an action type associated with the target object through an action model selector within the first AI model, based on the first hidden features, select a target action model from a set of candidate action models within the first AI model, based on the action type, determine an action sequence associated with the target object through the target action model, based on the second hidden features and the visual features, and transmit the action sequence to a robot; and
the robot configured to receive the action sequence and complete an action according to the action sequence.

13. The robot system of claim 12, wherein the set of candidate action models comprises a first model associated with an arm movement and a second model associated with a gripper manipulation.

14. The robot system of claim 13, wherein, for the determining of the action type, the server is configured to:
output a prediction value of the action type associated with the target object through the action model selector within the first AI model, based on the first hidden features;
determine the action type to be an arm movement, in response to the prediction value being less than a first threshold value; and
determine the action type to be a gripper manipulation, in response to the prediction value being greater than or equal to the first threshold value.

15. The robot system of claim 12, wherein
the visual features comprise global visual features and local visual features, and
for the determining of the action sequence, the server is configured to perform either one of:
determining the action sequence associated with the target object through the first model, based on the second hidden features and the global visual features, in response to the action type being an arm movement; and
determining the action sequence associated with the target object through the second model, based on the second hidden features and the local visual features, in response to the action type being a gripper manipulation.

16. The robot system of claim 13, wherein
the visual features comprise global visual features and local visual features, and
for the determining of the action sequence, the server is configured to perform either one of:
determining the action sequence associated with the target object through the first model, based on random noise, the second hidden features, and the global visual features, in response to the action type being an arm movement; and
determining the action sequence associated with the target object through the second model, based on random noise, the second hidden features, and the local visual features, in response to the action type being a gripper manipulation.

17. The robot system of claim 12, wherein
the feature extraction network comprises an encoder, a visual model, and a large language model (LLM),
for the determining of the visual features, the first hidden features, and the second hidden features, the server is configured to:
determine language features through the encoder, based on the first command;
determine first visual features and second visual features through the visual model, based on the scene image; and
determine the first hidden features and the second hidden features through the LLM, based on the first visual features and the language features,
the first visual features are used to represent a basic structure and/or local information of the scene image, and
the second visual features are used to represent semantic information of the scene image.

18. The robot system of claim 17, wherein
the LLM is an LLM Meta AI version 2 (LLAMA-2) model,
the first hidden features are acquired from hidden features of a second transformer layer of the LLAMA-2 model,
the second hidden features are acquired from hidden features of a last transformer layer,
the second transformer layer is used for action selection, and
the last transformer layer is used for action estimation.

19. The robot system of claim 17, wherein, for the determining of the action sequence, the server is configured to determine the action sequence associated with the target object through the target action model, based on the second hidden features and the second visual features.

20. An electronic device comprising:
one or more processors comprising processing circuitry; and
memory comprising one or more storage media storing instructions that, when executed individually or collectively by the one or more processors, cause the electronic device to:
determine an action type associated with a target object, based on first hidden features determined through a large language model (LLM) based on first visual features extracted from a scene image; and
based on the determined action type, determine an action sequence associated with the target object through either one of:
a first model associated with an arm movement, based on second hidden features determined through the LLM based on the first visual features and on global visual features extracted from the scene image; and
a second model associated with a gripper manipulation, based on the second hidden features and local visual features extracted from the scene image.
